(19) United States
(12) Patent Application Publication
(10) Pub. No.: US 2014/0238508 A1
(43) Pub. Date: Aug. 28, 2014

(54) PRESSURE REDUCING VALVE, TAP AND BOTTLE PROVIDED WITH SUCH A PRESSURE REDUCING VALVE

(71) Applicant: L'Air Liquide, Société Anonyme pour I'Etude et I'Exploitation des Procédés Georges Claude, Paris (FR)

(72) Inventors: Pedro Collado, Ozoir la Ferriere (FR); Damien Germani, Paris (FR); Phillippe Rudnianyn, Villers sur Orge (FR)

(73) Assignee: L'Air Liquide, Société Anonyme pour I'Etude I'Exploitation des Procédés Georges Claude, Paris (FR)

(21) Appl. No.: 14/189,031

(22) Filed: Feb. 25, 2014

(30) Foreign Application Priority Data
Feb. 26, 2013 (FR) 1351673

(51) Int. Cl. F16K 17/18

(52) U.S. Cl. CPC F16K 17/18
USPC 137/505.11

(57) ABSTRACT

Pressure reducing valve for compressed gas, comprising a body (1) housing a gas circuit (11) comprising an inlet (3) and an outlet (5), the gas circuit (11) comprising a mechanism for reducing the pressure of the gas between the inlet (3) and outlet (5), the reduction mechanism comprising a reduction piston (7) movable in the body (1) and sealingly delimiting a reduction chamber (16) via a gasket (15), the reduction piston (7) being able to move in translation in an upstream/downstream direction and acted on by a first return member (10), the pressure reducing valve (100) comprising a safety valve for preventing a rise in the pressure in the reduction chamber (16) beyond a given threshold, the safety valve comprising a discharge orifice (6) for the gas, the discharge orifice (6) being selectively in communication with the reduction chamber (16) when the reduction piston (7) reaches a given limit downstream position under the effect of the pressure in the reduction chamber (16), characterised in that the gasket (15) is disposed in a fixed housing of the body (1) and cooperates sealingly with the reduction piston (7) when the reduction piston (7) has not reached its given limit downstream position.

### CROSS REFERENCE TO RELATED APPLICATIONS

This application claims the benefit of priority under 35 U.S.C. §119 (a) and (b) to French Patent Application No. 1351673 filed Feb. 26, 2013, the entire contents of which are incorporated herein by reference.

### BACKGROUND

The present invention concerns a pressure reducing valve for compressed gas as well as a tap and pressurized gas bottle comprising such a pressure reducing valve.

### SUMMARY

The invention concerns more particularly a pressure reducing valve for compressed gas, in particular for a pressurized gas bottle tap, comprising a body housing a gas circuit comprising an inlet intended to be put in communication with gas at high pressure and an outlet intended to be connected to a downstream circuit, the gas circuit comprising a mechanism for reducing the pressure of the gas between the inlet and outlet to a given pressure level, the reduction mechanism comprising a reduction piston movable in the body and sealingly delimiting a reduction chamber via a gasket, the reduction piston being able to move in translation in an upstream/downstream direction and acted on by a first return member, the pressure reducing valve comprising a safety valve for preventing a rise in the pressure in the reduction chamber beyond a given threshold, the safety valve comprising a discharge orifice for the gas, the discharge orifice being selectively in communication with the reduction chamber when the reduction piston reaches a given limit downstream position under the effect of the pressure in the reduction chamber.

The invention concerns in particular gas pressure reduction valves of the piston type including a safety valve at the reduction piston.

Such a pressure reduction valve is described for example in the document FR 2706052 A1.

Such a device discharges the gas in the event of abnormal overpressure in the reduction chamber delimited by the reduction piston.

This known device does however have drawbacks. Thus the gasket of the reduction piston may undergo extrusion in certain configurations of opening of this valve (for example because of rubbing of the gasket against the reduction piston during a relatively long travel of the piston at high pressure).

One aim of the present invention is to overcome all or some of the drawbacks of the prior art noted above.

To this end, the pressure reducing valve according to the invention, moreover in accordance with the generic definition given thereof in the above preamble, is essentially characterised in that the gasket is disposed in a fixed housing of the body and cooperates sealingly with the reduction piston when the reduction piston has not reached its given limit downstream position.

Moreover, embodiments of the invention may comprise one or more of the following features:
the gasket is disposed in a housing situated, in the upstream/downstream direction, upstream of the discharge orifice,
when the reduction piston reaches the given limit downstream position, the gasket no longer sealingly cooperates with the reduction piston and provides a passage for the gas between the reduction chamber and the discharge orifice,
the gasket is toric and selectively cooperates sealingly with a cylindrical external surface of the reduction shutter piston,
the reduction mechanism comprises a reduction shutter able to move in translation in the upstream/downstream direction relative to a seat, the reduction shutter being urged downstream in the direction of the seat via a second return member, the reduction piston being urged upstream by the first return member in order to transmit a force to the reduction shutter opposite to the force of the second return member.

The invention also concerns a pressurized gas bottle tap comprising a pressure reducing valve integrated or attached removably on the tap, the pressure reducing valve being in accordance with any one of the aforementioned or following features.

The invention also concerns a pressurized gas bottle comprising such a tap.

The invention may also concern any alternative device or method comprising any combination of the aforementioned or following features.

### BRIEF DESCRIPTION OF THE DRAWINGS

For a further understanding of the nature and objects for the present invention, reference should be made to the following detailed description, taken in conjunction with the accompanying drawings, in which like elements are

FIG. 1 shows a schematic and partial view in section of a pressure reducing valve according to an example embodiment of the invention,

FIGS. 2 and 3 show partial and schematic views in section of a detail of the pressure reducing valve in FIG. 1 in respectively two operating configurations (safety valve closed in FIG. 2 and safety valve open in FIG. 3),

FIG. 4 shows a schematic and partial view of an example of a gas bottle provided with a tap comprising such a pressure reducing valve.

### DESCRIPTION OF PREFERRED EMBODIMENTS

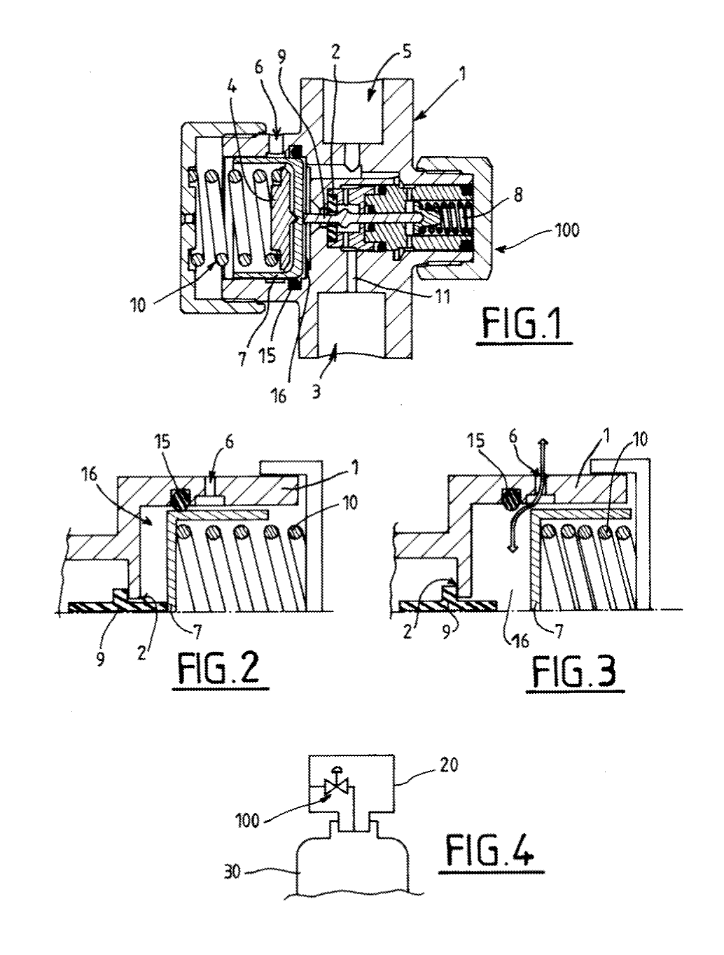

The example of a pressure reducing valve 100 illustrated in FIG. 1 comprises a body 1 housing a gas circuit 11 comprising an inlet 3 intended to be put in communication with gas at high pressure and an outlet 5 intended to be connected to a downstream circuit for supplying gas at the given reduced pressure.

The gas circuit 11 comprises a mechanism for reducing the pressure of the gas between the inlet 3 and the outlet 5 to a given pressure level (fixed or adjustable).

The reduction mechanism conventionally comprises a reduction piston 7 movable in the body 1 and sealingly delimiting a reduction chamber 16 via a gasket 15. The reduction piston 7 is able to move in translation in an upstream/downstream direction and is urged upstream by a first return member 10 such as a spring. As illustrated, an intermediate dish 4 can be disposed between the spring 10 and the reduction piston 7.

The reduction mechanism also comprises a reduction shutter 9 able to move in translation in the upstream/downstream direction relative to a seat 2. The reduction shutter 9 is urged downstream in the direction of the seat 2 via a second return member 8 such as a spring.

The reduction piston 7 is in contact with one end of the reduction valve 9. The reduction piston 10 is urged upstream by a first return member 10 in order to transmit a force to the reduction flap 9 opposite to the force of the second return member 8. The equilibrium of the opposing forces of the assembly provides opening of the seat 2, generating a reduction of the gas pressure to a fixed or adjustable given value.

Naturally, other reduction mechanisms can be envisaged and the rest of the structure of the reduction mechanism shown in FIG. 1 will not be described further in detail for reasons of concision.

The pressure reducing valve 100 also comprises a safety valve for preventing a pressure rise in the reduction chamber 16 beyond a given threshold, for example 5.5 bar. In addition, preferably, the flow rate of said valve must keep less than or equal to 10 bar downstream.

The safety valve comprises a discharge orifice 6 for the gas selectively connected with the reduction chamber 16 when the reduction piston 7 reaches a given limit downstream position under the effect of the pressure in the reduction chamber 16 (cf. FIG. 3).

According to an advantageous feature, said gasket 15 is disposed in a fixed housing in the body 1 and cooperates sealingly with the reduction piston 7 when the production piston 7 has not reached its given limit downstream position (cf. FIG. 2).

This configuration reduces or eliminates the risks of extrusion of the gasket 15.

In addition this structure significantly reduces the opening/closing hysteresis of the passage to the discharge orifice 6. That is to say the passage from an open state to a closed state is quicker and more immediate.

The inside diameter of the gasket 15 provides a seal on the outside circumference of the piston 7. The cross section of flow for the gas is increased in the open position. Friction is reduced.

In addition, this configuration requires a relatively small travel of the reduction piston 7 for passage from the sealed state (closed FIG. 2) to the non-sealed state (open FIG. 3) and vice versa.

As illustrated, preferably the gasket 15 is disposed in a housing (circular groove or throat for example) situated, in the upstream/downstream direction, upstream of the discharge orifice 17.

In addition, when the reduction piston 7 reaches the given limit downstream position, the gasket 15 no longer cooperates sealingly with the reduction piston 7 and provides a passage for the gas between the reduction chamber 16 and discharge orifice 6.

The gasket 15 is preferably toric and selectively cooperates sealingly with a cylindrical external surface of the reduction piston 7.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A pressure reducing valve for compressed gas, in particular for a pressurized gas bottle tap, comprising a body (1) housing a gas circuit (11) comprising an inlet (3) intended to be put in communication with gas at high pressure and an outlet (5) intended to be connected to a downstream circuit, the gas circuit (11) comprising a mechanism for reducing the pressure of the gas between the inlet (3) and outlet (5) to a given pressure level, the reduction mechanism comprising a reduction piston (7) movable in the body (1) and sealingly delimiting a reduction chamber (16) via a gasket (15), the reduction piston (7) being able to move in translation in an upstream/downstream direction and acted on by a first return member (10), the pressure reducing valve (100) comprising a safety valve for preventing a rise in the pressure in the reduction chamber (16) beyond a given threshold, the safety valve comprising a discharge orifice (6) for the gas, the discharge orifice (6) being selectively in communication with the reduction chamber (16) when the reduction piston (7) reaches a given limit downstream position under the effect of the pressure in the reduction chamber (16), wherein the gasket (15) is disposed in a fixed housing of the body (1) and cooperates sealingly with the reduction piston (7) when the reduction piston (7) has not reached its given limit downstream position.

2. The pressure reducing valve of claim 1, wherein the gasket (15) is disposed in a housing situated, in the upstream/downstream direction, upstream of the discharge orifice (6).

3. The pressure reducing valve of claim 1, wherein, when the reduction piston (7) reaches the given limit downstream position, the gasket (15) no longer cooperates sealingly with the reduction piston (7) and provides a passage for the gas between the reduction chamber (16) and the discharge orifice (6).

4. The pressure reducing valve of claim 1, wherein the gasket (15) is toric and selectively cooperates sealingly with a cylindrical external surface of the reduction piston (7).

5. The pressure reducing valve claim 1, wherein the reduction mechanism comprises a reduction shutter (9) able to move in translation in the upstream/downstream direction relative to a seat (2), the reduction shutter (9) being urged downstream in the direction of the seat (2) by a second return member (8), the reduction piston (10) being urged upstream by the first return member (10) in order to transmit a force to the reduction flap (9) opposite to the force of the second return member (8).

6. A pressurized gas bottle tap comprising a pressure reducing valve (100) integrated or attached removably to the tap (20), wherein the pressure reducing valve (100) is in accordance with claim 1.

7. The pressurized gas bottle comprising a tap according to claim 6.
